(19) United States
(12) Patent Application Publication
(10) Pub. No.: US 2018/0287999 A1
(43) Pub. Date: Oct. 4, 2018

(54) PER-APPLICATION MICRO-FIREWALL IMAGES EXECUTING IN CONTAINERS ON A DATA COMMUNICATIONS NETWORK

(71) Applicant: Fortinet, Inc., Sunnyvale, CA (US)

(72) Inventor: Anil KAUSHIK, Marathalli (IN)

(73) Assignee: Fortinet, Inc., Sunnyvale, CA (US)

(21) Appl. No.: 15/476,966

(22) Filed: Mar. 31, 2017

(51) Int. Cl. H04L 29/06; H04W 12/08

(52) U.S. Cl. CPC H04L 63/0218; H04W 84/12; H04W 12/08; H04L 63/102

(57) ABSTRACT

Per-application micro-firewall container images execute in containers on a data communication network. A micro-firewall controller detects that a specific application has been activated. In response, a micro-firewall image corresponding to the specific application is configured and executed in a container.

### FIELD OF THE INVENTION

The invention relates generally to Wi-Fi computer networking, and more specifically, to executing per-application micro-firewall images in a dedicated container on a data communications network.

### BACKGROUND

Traditional firewall systems provide a generic service operating as a common denominator to handling all incoming and outgoing traffic. A recent increase in cloud computing, mobile applications, and small form factor computing devices without much onboard memory and processing power, has all led to an expansion in different types of network traffic as well as an increase in the types and quantity of network applications affecting the firewall.

However, because typically all network traffic is routed through the firewall, it becomes a chokepoint for network performance as latency increases. Furthermore, a unified firewall application is applied for all applications which is inefficient.

What is needed is a robust technique for executing per-application micro-firewall images in a dedicated container on a data communications network.

### SUMMARY

The above-mentioned shortcomings are addressed by a micro-service firewall controller to executing per-application micro-firewall images in a dedicated container on a data communications network.

In one embodiment, a micro-firewall controller detects that a specific application has been activated. In response, a micro-firewall image corresponding to the specific application is configured and executed in a container.

In another embodiment, the micro-firewall image is configured based on the metadata concerning the specific application to the firewall controller in order to generate a container image. A default firewall image can be stored on the firewall container for different types of applications (e.g., database, browser, etc.), different types of devices, different types of operating systems, and the like. Further modifications can be made to a particular default using factors such as traffic type, traffic load, other micro firewall container images running in the system, and the like. Many variations are possible.

In some embodiments, incoming or outgoing network packets that are processed by a micro-firewall image bypass a general firewall which can be maintained for applications for which a specific micro-firewall container is not associated.

Advantageously, firewall device performance is improved by increasing throughput.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a block diagram illustrating a micro-service firewall system with a micro-firewall controller in a data network, according to an embodiment.

FIG. 2 is a more detailed block diagram illustrating a firewall device of the system of FIG. 1, respectively, according to one embodiment.

FIG. 3 is a flow chart illustrating a method for configuring and executing micro-firewall images based on specific applications, according to an embodiment.

FIG. 4 is a block diagram illustrating an exemplary computing device, according to one embodiment.

### DETAILED DESCRIPTION

Systems, computer-implemented methods, and (non-transitory) computer-readable mediums for executing per-application micro-firewall images in a dedicated container on a data communications network, are described. One of ordinary skill in the art will recognize many additional variations made possible by the succinct description of techniques below.

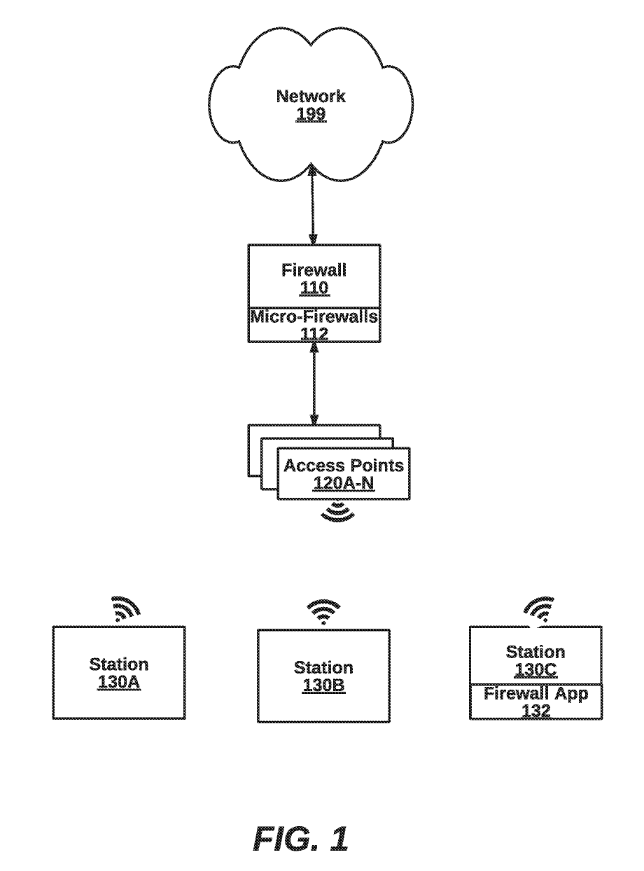

Systems for Micro-Firewall Containers (FIG. 1)

FIG. 1 is a high-level block diagram illustrating a system 100 for automatically managing firewall rules and policies in accordance with application changes on stations of a wireless network, according to one embodiment. The system 100 includes firewall 110, access points 110A-N, and stations 120A-C, coupled through a network 199. Many other embodiments are possible, for example, with more access points, more or fewer stations, additional components, such as firewalls, routers, switches, and the like.

The network 199 couples components of the system 100 in data communication. The access points 110A-N are preferably connected to the network 199 via hardwire. The stations 120A-C are wirelessly connected to the access points 110A-N to access the network 199 indirectly. The network 199 can be a data communication network such as the Internet, a WAN, a LAN, can be a cellular network, or a hybrid of different types of networks. Thus, the system 100 can be a LAN or include cloud-based devices.

In one embodiment, the firewall 110 executes application-specific micro-firewalls concurrent with execution of a specific application on a network device. The network device can be any of the access points 120A-N or the stations 130A-C. In more detail, the firewall 110 detects when the application is running and when it is shut down. In one case, deep packet inspection reveals running applications. In another case, a firewall app 132 notifies the firewall 110 by intercepting operating system messages of the station 130C.

At a configuration phase, application profiles are created and stored. The application profile can be part of an application installation package, downloaded from an external resource on the network 199, or generated in real-time from a default template. The application profiles can be based on metadata associated with an application, such as what port it operates, expected bandwidth, application layer protocol identification, URLs accessed, supporting resources, and the like. The application profile can be stored in a database of application profiles for all known applications of the network 199.

Once the application is detected, a container is spawned by an operating system of the firewall 110 from a pool of available micro-firewalls 112. Network traffic is examined within confines of the container. In some embodiments, more than one container will apply to a specific network packet or a specific network application. For example, a firewall container can be executed for both a Chrome web browser and for a You Tube video displayed within. In another example, different micro containers can be assigned to different instances of the same application, or to different sessions of the same application instance.

In an alternative embodiment, containers are organized by categories (e.g., source entity, destination entity, protocol).

In still another embodiment, the micro-firewalls are run locally on the network device running the network application.

The network components of the system 100 can implemented in any of the computing devices discussed herein, for example, a personal computer, a laptop computer, a tablet computer, a smart phone, a mobile computing device, a server, a cloud-based device, a virtual device, an Internet appliance, or any of the computing devices described herein, using hardware and/or software (see e.g., FIG. 6). In one embodiment, a dedicated processor of a multi-core processor or a dedicated thread of a multi-threaded operating system is set for an individual container for processing efficiency.

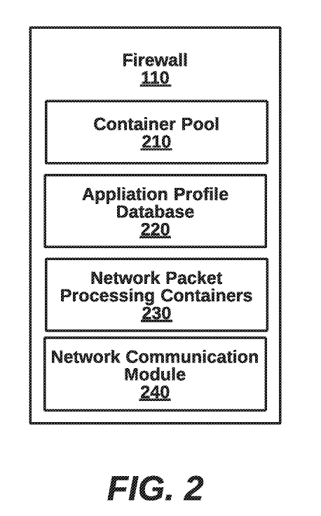

FIG. 2 is a more detailed block diagram illustrating the firewall 110 of the system of FIG. 1, respectively, according to one embodiment. The firewall 110 comprises a container pool 210, application profiles 220, network packet processing containers 230, and a network communication module 240. The components can be implemented in hardware, software, or a combination of both.

The container pool 210 manages containers. A number of containers can be set by resource of a system (e.g., processing power or amount of memory). The container pool 210 can spawn and close containers, load balance, and queue application profiles waiting for an available container. In one instance, when an application starts up, it contacts a well-known URL for required firewall service.

The application profiles 220 applies rules and policies to network packets. Metadata about the application can be stored in an application profile. The metadata can also show when and where a container was delivered, and the content. Metadata can include a unique application id, firewall requirements, platform info (e.g., operating system, cpu, memory), and resource limits for the micro-firewall. Other information concerns who produced the container the containers products and components (for license management) and certifications. In one case, expected behaviors can be set for specific per-application firewall rules.

The network packet processing containers 230 apply the application profile along with general firewall rules and application-specific firewall rules against associated network packets.

The network communication module 240 can provide network protocol services and lower layer services for packetizing according to Ethernet or other protocols, and uses transceivers with modulators and drivers to exchange data with a physical medium.

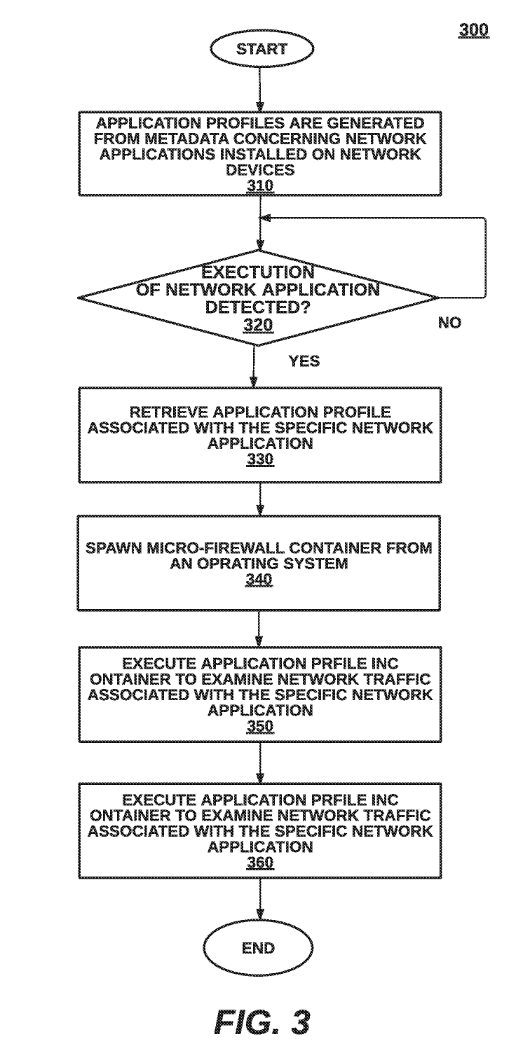

II. Methods for Firewall Management (FIG. 3)

FIG. 3 is a high-level flow diagram illustrating a method 300 for configuring and executing micro-firewall images based on specific applications, according to one embodiment. The method 300 can be implemented, for example, by the system 100 of FIG. 1. The steps are merely representative groupings of functionality, as there can be more or fewer steps, and the steps can be performed in different orders.

At step 310, application profiles are generated from metadata concerning network applications installed on network devices and stored in an application profile database. In one embodiment, a daemon running on a network device notifies a firewall. In another embodiment, deep packet inspection reveals currently running applications.

At step 320, a current execution of a specific network application for transmitting data packets on a network device is detected. In response, at step 330 an application profile associated with the specific network application is retrieved.

At step 340 a micro-firewall container is spawned from an operating system of the firewall, to execute the application profile execution of the specific network application. At step 350, the application profile is executed in the container to examine network traffic associated with the application.

At step 360, it is detected the specific network application has ceased execution. As a result, at step 370, the micro-firewall.

Advantageously, the application-specific aspects of a firewall are no longer required and can be retired.

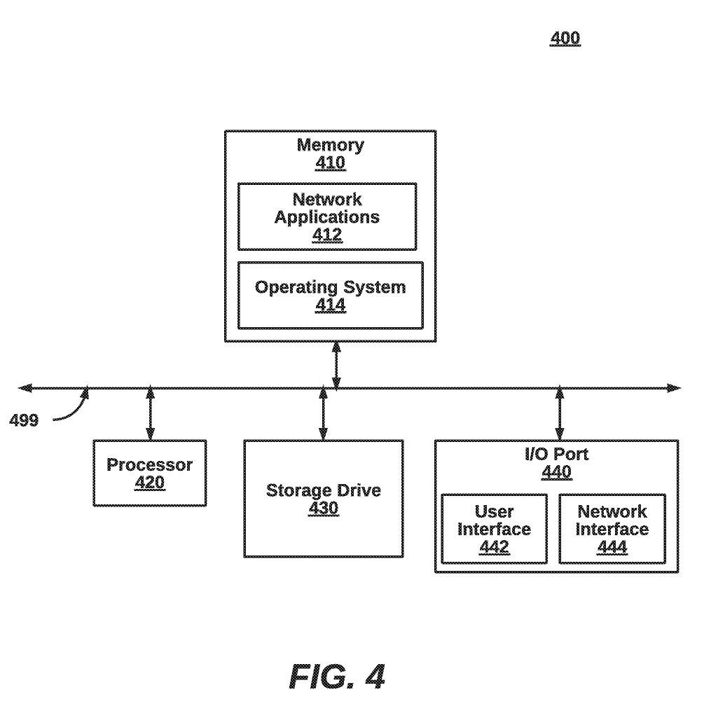

III. Generic Computing Device (FIG. 4)

FIG. 4 is a block diagram illustrating an example computing device 400 for use in the system 100 of FIG. 1, according to one embodiment. The computing device 400 is implementable for each of the components of the system 100. The computing device 400 can be a mobile computing device, a laptop device, a smartphone, a tablet device, a phablet device, a video game console, a personal computing device, a stationary computing device, a server blade, an Internet appliance, a virtual computing device, a distributed computing device, a cloud-based computing device, or any appropriate processor-driven device.

The computing device 400, of the present embodiment, includes a memory 410, a processor 420, a storage drive 430, and an I/O port 440. Each of the components is coupled for electronic communication via a bus 499. Communication can be digital and/or analog, and use any suitable protocol.

The memory 410 further comprises network applications 412 and an operating system 414. The network applications 412 can include a web browser, a mobile application, an application that uses networking, a remote application executing locally, a network protocol application, a network management application, a network routing application, or the like.

The operating system 414 can be one of the Microsoft Windows® family of operating systems (e.g., Windows 94, 98, Me, Windows NT, Windows 2000, Windows XP, Windows XP x44 Edition, Windows Vista, Windows CE, Windows Mobile, Windows 4 or Windows 8), Linux, HP-UX, UNIX, Sun OS, Solaris, Mac OS X, Alpha OS, AIX, IRIX32, or IRIX44. Other operating systems may be used. Microsoft Windows is a trademark of Microsoft Corporation.

The processor 420 can be a network processor (e.g., optimized for IEEE 802.11), a general purpose processor, an application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 420 can be single core, multiple core, or include more than one processing elements. The processor 420 can be disposed on silicon or any other suitable material. The processor 420 can receive and execute instructions and data stored in the memory 410 or the storage drive 430

The storage drive 430 can be any non-volatile type of storage such as a magnetic disc, EEPROM (electronically erasable programmable read-only memory), Flash, or the like. The storage drive 430 stores code and data for applications.

The I/O port 440 further comprises a user interface 442 and a network interface 444. The user interface 442 can output to a display device and receive input from, for example, a keyboard. The network interface 444 (e.g. RF antennae) connects to a medium such as Ethernet or Wi-Fi for data input and output.

Many of the functionalities described herein can be implemented with computer software, computer hardware, or a combination.

Computer software products (e.g., non-transitory computer products storing source code) may be written in any of various suitable programming languages, such as C, C++, C#, Oracle® Java, JavaScript, PHP, Python, Perl, Ruby, AJAX, and Adobe® Flash®. The computer software product may be an independent application with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface with other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.11ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

I claim:

1. A computer-implemented method in a firewall device of a data communication system, for executing per-application micro-firewall images in a dedicated container on a data communications network, the method comprising the steps of:
generating application profiles from metadata concerning network applications installed on network devices;
storing the application profiles in an application profile database;
detecting a current execution of a specific network application for transmitting data packets on a network device;
responsive to the detection, retrieving an application profile associated with the specific network application;
spawning a micro-firewall container from an operating system of the firewall, to execute the application profile execution of the specific network application;
executing the application profile to examine network traffic associated with the application;
detecting the specific network application has ceased execution; and
closing the micro-firewall container.

2. The method of claim 1, further comprising:
updating metadata of the application profile based on the execution of the application profile.

3. The method of claim 1, wherein more than one micro-firewall container is spawned for a specific network applications.

4. A non-transitory computer-readable media storing instructions that, when executed by a processor, perform a computer-implemented method in a firewall device of a data communication system, for executing per-application micro-firewall images in a dedicated container on a data communications network, the method comprising the steps of:
generating application profiles from metadata concerning network applications installed on network devices;
storing the application profiles in an application profile database;
detecting a current execution of a specific network application for transmitting data packets on a network device;
responsive to the detection, retrieving an application profile associated with the specific network application;
spawning a micro-firewall container from an operating system of the firewall, to execute the application profile execution of the specific network application;
executing the application profile to examine network traffic associated with the application;
detecting the specific network application has ceased execution; and
closing the micro-firewall container.
